(19) United States
(12) Patent Application Publication
(10) Pub. No.: US 2005/0162514 A1
(43) Pub. Date: Jul. 28, 2005

(54) Plural-receptor, plural-mode, surveillance imaging system and methodology with task-minimizing, view-establishment control

(76) Inventors: Michael R. Dennis, Scappoose, OR (US); David M. Dennis, Scappoose, OR (US)

Correspondence Address: ROBERT D. VARITZ, P.C., 2007 S.E. Grant Street, Portland, OR, 97201, US

(21) Appl. No.: 10/633,053

(22) Filed: Jul. 31, 2003

Related U.S. Application Data
(60) Provisional application No. 60/484,264, filed on Jun. 30, 2003.

(51) Int. Cl. H04N 7/18

(52) U.S. Cl. 348/143

(57) ABSTRACT

A plural-mode, plural-receptor surveillance imaging system and methodology which offer very simple, versatile one-handed control over the operations and viewing orientations of three different surveillance imagers, thus to minimize the tasks involved in controlling the specific surveillance views which are established and presented by these imagers. Provided for allowing such control are a one-hand-operable, intuitive touch-screen and joystick controller structure, and a appropriate computer for translating user control actions accurately into changes in system behavior. This one-handedness characteristic promotes an operational environment in which the larger share of a user/operator's attention can successfully be focused on the received surveillance imagery, per se, rather than upon details of operating a control.

### CROSS-REFERENCE TO RELATED APPLICATION

This application claims priority to U.S. Provisional Patent Application Serial No. 60/484,264, filed Jun. 30, 2003, for “Surveillance Imaging System and Methodology”. The entirety of this priority patent application is hereby incorporated herein by reference.

### BACKGROUND AND SUMMARY OF THE INVENTION

This invention pertains to surveillance imaging apparatus and methodology. In particular, it relates to a multi-information-character, surveillance imaging system and methodology which employs three commonly “aimed”, motion-unitized imagers, all of which are easily and essentially one-handedly controllable in all respects from a single and highly intuitive remote controller structure. This controller structure, under computer-associated influence, offers touch-screen button, and joystick controller, functions that are effective to steer the imagers' shared point of view, as well as to enable quick and easy adjustments and modifications of individual operating parameters of each imager. The three mentioned imagers include (a) an optical, daytime, color video imager, (b) an optical, nighttime, light-intensified, black-and-white imager, and (c) a thermal imager, all contained within a compact, unitizing housing.

For the purpose of illustration herein, a preferred and best mode embodiment of, and manner of practicing, the invention, are described in the setting of an overall surveillance imaging system which has other interesting structural and operational features that play useful roles in the implementation of surveillance imaging. In this surveillance environment, the structural and methodological contributions of the present invention play significant roles in making the operational tasks of a user who is operating a system employing the present invention extremely simple with respect to the nature and complexity of many tasks that need to be performed in order to offer high flexibility and selectability in the establishment and control over surveillance imaging. Additionally, the structure and methodology of the present invention enable a system user, whether operating the system under full daylight, or in heavily darkened conditions, to concentrate principal visual attention on screen displays of surveillance imagery, rather than on complex hardware controls required for manipulating various system-adjustment operational parameters.

Thinking about the large range of operational settings wherein the present invention can offer significant advantage, there are many applications where it is desirable to provide imaging surveillance capabilities that are functional under a wide range of lighting circumstances, including full daytime surveillance circumstances, very dark nighttime scene surveillance circumstances, and, at any time of day, thermal surveillance circumstances. Each of these three approaches (daytime color, nighttime intensified, and thermal) to imaging surveillance is useful to provide different specific kinds of information, and it is especially desirable, in many applications, to have the capability of comparing, either by time-sequencing, or in side-by-side simultaneous displaying, of viewable surveillance imagery drawn from different ones of these several imaging possibilities. For example, during daytime surveillance, the visible color spectrum may yield quite a bit of information about a scene being viewed, but may not necessarily reveal certain important information that can only be displayed thermally regarding the same “scene”. By providing a system in which both of these kinds (daylight color and thermal) of surveillance information can be viewed in any one of several comparative and augmenting modes, and with “fine-tuning” parameter control being exercised simply and one-handedly regarding the different imagers, quite a bit of important information not available just by use of one of these two modes becomes accessible.

Considering another situation wherein different, easily controllable surveillance imaging modes may be important, during those times of day near dawn, and near and after sunset, it might be desirable to view a scene from several different imaging points of view, such as from the perspective of a daylight, color, video imager, from that of a nighttime, light-intensified imager, and from that of a thermal imager. Deceptive lighting conditions which typically exist during these times of day, can become more readily decipherable if one can, for example, sequentially view input information derived alternatively by a daytime, color, video imager and by a nighttime, light-intensified imager. Switching back and forth easily between these modes under such circumstances is, of course, very desirable. It is also extremely useful to have available, in an easily manipulated way, the opportunity to view the very same scene condition with a thermal imager for acquiring additional comparative surveillance information.

At nighttime, it is important to be able, in many instances, to have available both thermal and nighttime, light-intensified, optical surveillance imagery available, and it is important with regard to this comparative surveillance mode of operation that a surveillance observer be presented with system control structure which can be worked easily and accurately in the dark.

Thus there are many circumstances wherein it is important that a user of a system designed for imagery surveillance employing plural imager modes of acquiring surveillance data be rapidly changeable and configurable in order to provide, quickly, useful surveillance information under a relatively wide variety of environmental and other circumstantial conditions. The present invention takes special aim at providing a unique and highly intuitive, one-hand-operable, touch-screen and joystick controller structure which, cooperating with an appropriately programmed computer, and with computer controllable “steering motors”, can effect maneuvers and adjustments of the operating parameters and dispositions of “imaging elements” in the system so as to afford very easy-to-use, task-minimized, flexible surveillance opportunities for a system user.

The system and methodology of the present invention uniquely address all of these considerations in a very practical, reliable, and relatively simple manner. The various features and advantages which are offered by the invention will now become more fully apparent as the description which follows is read in conjunction with the accompanying drawings.

### DESCRIPTION OF THE DRAWINGS

FIG. 1A is a simplified and stylized isometric view of a multi-imager surveillance system which employs plural-mode, plural receptors (imagers), and an intuitive, one-hand-operable, task-minimizing computer-based controller, which are organized and operable in accordance with a preferred and best mode embodiment of, and manner of practicing, the present invention. At the right side of this figure, fragmentary dash-double-dot lines illustrate one modified form of the system which is pictured centrally in the figure.

FIG. 1B is a simplified block/schematic illustration of another modified form of the system centrally pictured in FIG. 1A.

FIG. 2 is a fragmentary view of that portion of the system illustrated in FIG. 1A which features a housing-enclosed assembly of plural (three) imagers, commonly bore-sighted at infinity, and unified for linked panning and tilting surveillance tracking motions under the control of structure which embodies the present invention.

FIG. 3 pictures a computer-generated display on a user-interface touch screen in a computer-based controller constructed in accordance with the present invention and incorporated in the system pictured in FIG. 1A. This figure shows a typical screen appearance for a situation where currently co-active in the system are a daytime color imager and a thermal imager, and illustrates the various one-hand-operable control functions which are furnished according to the invention to control various system parameters.

FIG. 4 is similar to FIG. 3, except that here what is shown is a typical touch-screen display provided in accordance with the invention under circumstances where currently co-active in the system of the invention are a light-intensified, black-and-white, nighttime imager, and a thermal imager.

FIG. 5 is similar to FIGS. 3 and 4, except that here what is shown is a user-interface touch screen provided according to the invention under circumstances where only the thermal imager in the system of FIG. 1A is currently active.

The specific touch-screen appearances shown in FIGS. 3-5, inclusive, should be understood to be representative only a few of many other kinds of intuitive, one-hand-operable, touch-screen control displays that may be made available in accordance with practice of the present invention.

FIGS. 6 and 7, are, respectively, photographic representations of actual screen views of comparative thermal and daytime, color video imagery that might be furnished for viewing under circumstances where what is presented on a touch screen, in accordance with the present invention, might look somewhat like what is shown in FIG. 3. In these two images, one can see that a central crosshair made visible on display screens in the system shown in FIG. 1A occupies one particular position relative to the location of a flying helicopter which is pictured in FIGS. 6 and 7.

FIGS. 8 and 9 are related to FIGS. 6 and 7, respectively, in that they show very similar images, but with a difference which is that the user/operator of the system of FIG. 1A has manipulated, one-handedly, a joystick controller provided in accordance with the invention to shift, simultaneously, the points of view (note the shifted positions of the crosshair) of the thermal imager and the daytime color imager provided in the system of FIG. 1A.

FIG. 10 is another photographic reproduction of a screen display derived from the thermal imager in the system of FIG. 1A, illustrating how a user/operator of that system has manipulated (again one-handedly) the field-of-view parameter control for the thermal imager in order to provide a more wide-angle thermal view of the same flying helicopter which is pictured in FIGS. 6 and 8.

FIGS. 11 and 12 show, respectively, photographic reproductions of two, similar display images provided by the nighttime, black-and-white, light-intensified imager employed in the system of FIG. 1A, wherein a human figure can be seen walking on the ground, and wherein further, in relation to the position of a target crosshair presented in FIG. 11, the operator has shifted the point of view of the nighttime imager to place this crosshair more nearly in “contact” with the observed human figure. This adjustment has been performed by a simple one-handed operation by a user/operator of the system of FIG. 1A, all in accordance with practice of the present invention.

FIGS. 13 and 14 are similar to FIGS. 11 and 12, respectively, except that what is here shown is imagery derived from the thermal imager in the system of FIG. 1A of the same human walking figure shown in FIGS. 11 and 12.

### DETAILED DESCRIPTION OF THE INVENTION

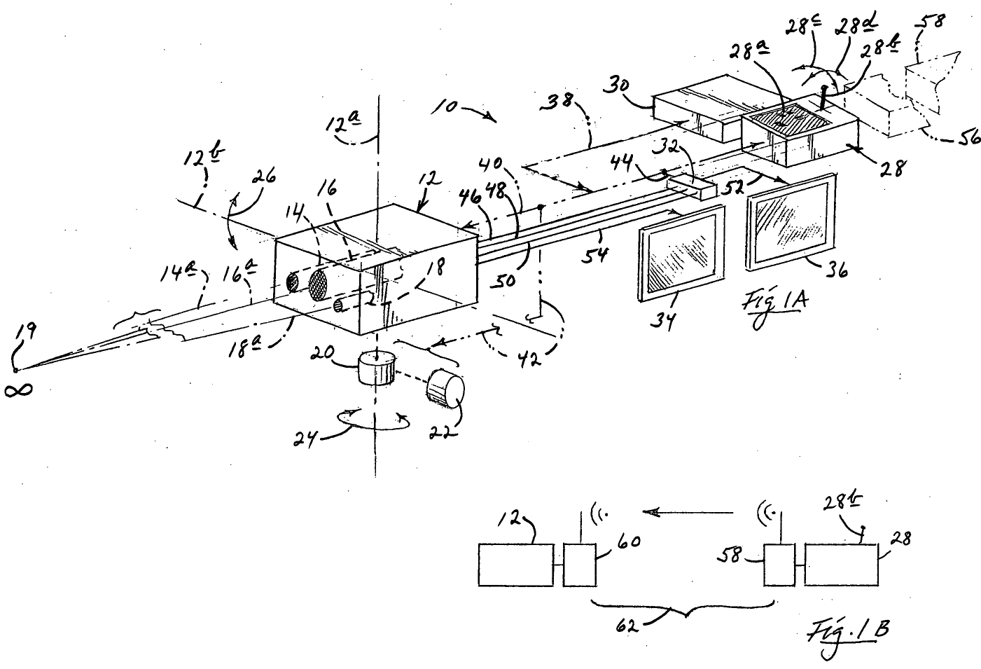

Turning attention now to the drawings, and referring first of all to FIG. 1A, indicated generally at 10 is a multi-information-character surveillance imaging system which includes structure for, and which operates (practices and implements methodology) in accordance with, task-minimizing, surveillance view-establishment control in accordance with the preferred and best mode embodiment of, and manner of practicing, the present invention. Provided in system 10 are a common housing structure, or housing, 12 which is appropriately environmentally sealed, and which contains a plural-mode, plural-imager assembly of three different surveillance imagers, including (a) an optical, light-intensified, black-and-white, nighttime video imager 14, (b) a thermal imager 16, and (c) an optical, daytime, color video imager 18.

Drivingly and mountingly connected to housing 12, which housing is suitably supported on a stand (not shown), are two computer-controllable electrical motors 20, 22, also referred to herein as computer-controllable, motor-actuatable drive, or mounting, structure. Motor 20 is selectively operable by an operator/user of system 10 to cause housing 12 (and the contained assembly of imagers) to swing as a unit reversibly back-and-forth angularly (in yaw or panning motion) about a generally upright axis shown at 12a. Such swinging motion is generally indicated in FIG. 1A by double-ended, curved arrow 24 in this figure. Similarly, motor 22 is likewise selectively operable to cause reversible up-and-down angular tilting (a pitch motion) of housing 12, and of the contained imagers, about a generally horizontal axis 12b. This motion is indicated by double-ended, curved arrow 26 in FIG. 1A. Suitably interposed housing 12 and the mentioned (but not illustrated) stand, is conventional motion/articulating structure (also not shown) which enablingly assists in supporting housing 12 on the stand for such motions.

Each of imagers 14, 16, 18 is provided with suitable computer-adjustable control structure for effecting selectable changes in various parameters, such as magnification, field of view, focus, and any other appropriate operational parameters. The exact parameters which are associated controllably with each of imagers 14, 16, 18 do not form any part of the present invention.

Further describing generally the assembly, or arrangement, of the three imagers in accordance with this invention, imagers 14, 16, 18 are commonly bore-sighted, or bore-sight aligned, along their respective optical (or imaging) axes 14a, 16a, 18a, at infinity which is represented schematically at 19 on the left side of FIG. 1A. The terminology “commonly bore-sighted” refers to the fact that, effectively at infinity, all three imagers are aimed substantially exactly at the same point in space. An important consequence of this common, or matching, bore-sight alignment is that all of these different-mode imagers are always effectively looking at a surveillance scene with a substantially matching point of view, though not necessarily, as will be seen with the same field of view. This important shared alignment leads significantly to highly informative, comparative, surveillance observation and interpretation.

Further included in system 10 are (a) a user-operable controller (or controller interface) 28 having a touch-sensitive screen (or touch-screen display device) 28a, and a multi-axis, manual joystick (also called a joystick instrument) shown at 28b, (b) an appropriate computer 30, (c) video signal switching structure 32, and (d) a pair of conventional video screen display devices 34, 36, also referred to herein both as visual display devices, and as screen imagery display structure.

Within controller 28, touch screen 28a, through appropriate programming which is managed by computer 30, which computer is appropriately, operatively coupled (not specifically shown) to controller 28, enables a user, easily, conveniently and one-handedly, to select and control, among other things, the various operating parameters of imagers 14, 16, 18. Such one-handed-possible control enables quite complex and sophisticated control over the housing and the contained imagers. This control includes, for example, switching the three imagers selectively and individually into and out of operation, adjusting focus, establishing magnification and thus field of view, and making changes in any other appropriate parameters. Manual joystick 28b is, of course, one-handedly rockable in manners generally indicated by double-ended, curved arrows 28c, 28d to effect pitch and yaw angular motions, respectively, of the housing and imager assembly via motors 22, 20, respectively. While a manual, mechanical joystick is specifically shown in controller 28, it should be understood that joystick functionality may, if desired, be provided in a virtual sense by way of an appropriate touchable screen image provided on touch screen 28a under the control of computer 30.

Appropriately associated computer-active control lines 38, 40, 42, 44 extend operatively as shown between housing 12 (and the imagers contained therein), motors 20, 22, controller 28, computer 30, and switching structure 32. It is through these lines that control is exercised, via controller 28 and the operation of computer 30, over the imagers' parameter adjustments, the motor operations, and the operations of switching structure 32. Three additional lines 46, 48, 40 are shown extending between housing 12 and switching structure 32, and another line 52 is shown interconnecting structure 32 and display device 36. Still another line 54 is shown interconnecting housing 12 and display device 34.

In most applications, it is especially convenient to have available two display devices incorporated into system 10 as illustrated. With this arrangement, daytime and nighttime images presented selectively on the screen in display device 36 can be cross-related instantly to comparable thermal imagery presented dedicatedly on the screen in display device 34. In other applications, a user may wish to have available only a single active display device, such as device 36, on whose screen outputs from each of the three imagers may be selectively and exclusively presented at a given time. In all applications, the system and methodology of this invention enable full and quite intuitive one-handed control, nearly simultaneously, over all of the imaging-related structure in the system.

Lines 46, 48, 50 carry video output signals from imagers 14, 16, 18, respectively, to switching structure 32. Under the control of touch screen 28a and computer 30, a user/operator can selectively send a signal from any one of these three imagers over line 52 for display of an image on display device 36. Thus display device 36 can selectively display an image either from nighttime imager 14, from thermal imager 16, or from daytime imager 18. Line 54 dedicatedly delivers video output image information from thermal imager 16 directly to video display device 34.

With further reference to FIG. 1A, shown in dash-double-dot, fragmentary lines 56, 58 at the right side of this figure are portions of two additional controllers which are like controller 28. These additional controllers can be employed, in accordance with one modification of system 10, to offer places for user control that are distributed to different locations. While two such additional controllers are shown at 56, 58, it should be understood that any number of additional controllers, including only a single additional controller, may be employed advantageously if desired.

Still considering systemic modifications that can be made, yet another modification is illustrated generally in FIG. 1B. Here, in very simplified form, a controller 28 is shown operatively connected to a wireless transmitting device 58 which is designed to transmit control information from controller 28 to operable equipment associated with imager housing 12, including all of the imagers provided therein, and the pitch and yaw drive motors. Information transmitted by device 58 is received by an appropriate receiver which is shown at 60 in FIG. 1B, which receiver is suitably operatively connected to all of the controllable apparatus associated with housing 12. The wireless transmission medium employed may be a radio system, a wireless telephone system, the Internet, and so on. A bracket 62 provided in FIG. 1B is presented to emphasize the operative connectedness which exists between blocks 58, 60 in FIG. 1B.

Turning attention now to FIG. 2 in the drawings, here housing 12, imagers 14, 16, 18, controller 28, control lines 40, 42, and a single block which represents both of motors 20, 22, are shown isolated from other structure in system 10. FIG. 2 thus specifically focuses attention on core, interconnected, cooperative elements that are provided in system 10, in accordance with the present invention, to implement and enable what is referred to herein as task-minimizing, surveillance view-establishment control in the “hand” of a system user/operator. Very specifically, what can be seen readily in this figure are the operative interconnections—control interconnections—which exist between the assembly of imagers within housing 12, motors 20, 22, and the touch screen and joystick components of controller 28. Reiterating what has been said earlier herein, FIG. 2 clearly illustrates the simple one-hand-operation-enabling characteristic of the invention, according to which characteristic, a user employing system 10 can one-handedly operate the system through touch screen 28a, and joystick 28b.

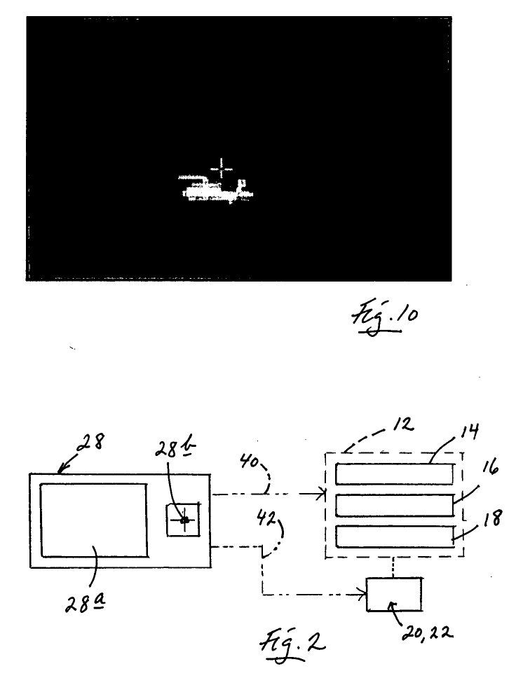

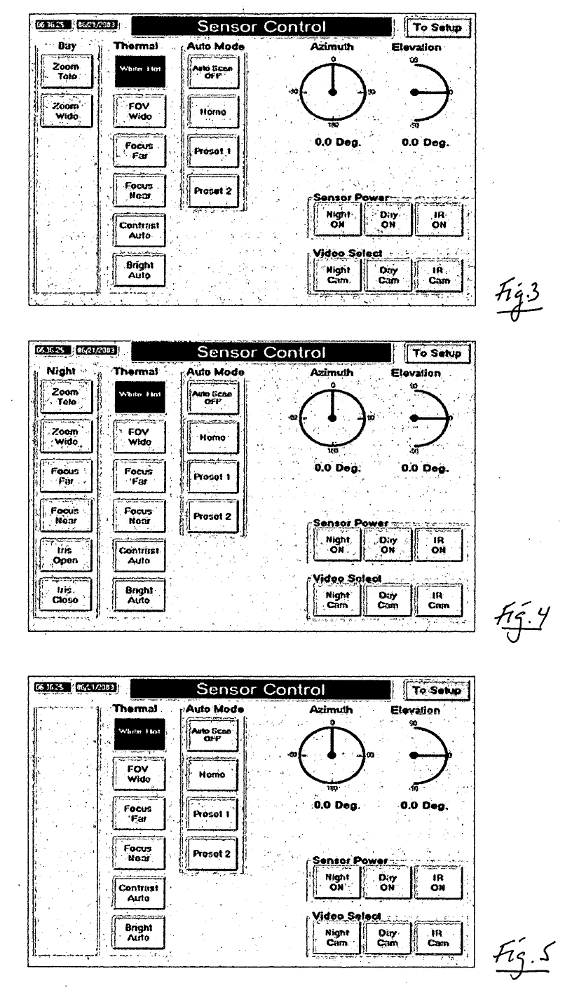

FIGS. 3-5, inclusive, illustrate typical virtual control interfaces that may be presented on touch screen 28a to enable a system user to implement full internal control over the operating parameters associated with imagers 14, 16 and 18. FIG. 3 specifically illustrates a situation wherein the daytime and thermal imagers, 18, 16, respectively, are actively being used in the system. With these two imager activated, imagery like that presented in FIGS. 6-10, inclusive, may be presented on display devices 34, 36. FIGS. 6 and 7 illustrate, respectively, and as was mentioned briefly earlier, a thermal image and a daytime, color image of a close-up view of a flying helicopter. A targeting crosshair appears in these two figures in very close proximity to, and just above, the upper central portion of the body of the imaged helicopter.

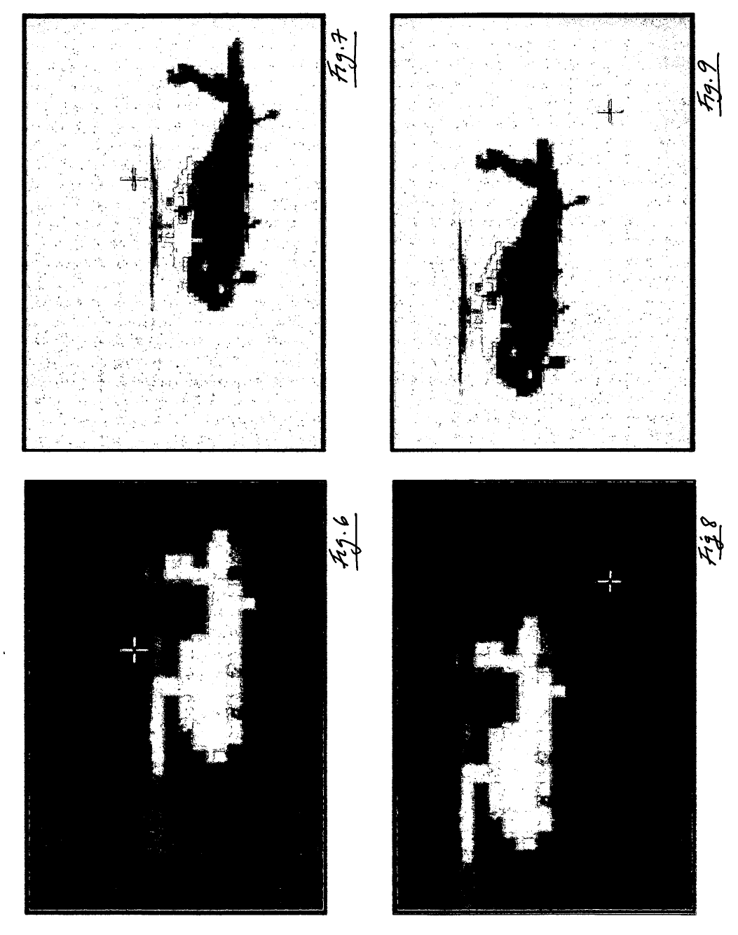

FIGS. 8 and 9 illustrate a situation wherein, with views like those shown in FIGS. 6 and 7 initially established, the system operator has chosen to implement a slight tilting and panning motion to shift the relative positions of the targeting crosshair and the imaged helicopter. This will have been done through simple bi-axial, one-handed manipulation of joystick 28b. One can see in FIGS. 8 and 9 how, simultaneously, the respective fields of view of the thermal and daytime, color imagers have shifted similarly, and how the targeting crosshair has been moved below and slightly to the right of the imaged helicopter. The imaged helicopter appears within the frames of these two figures (8 and 9) at different locations than those shown in FIGS. 6 and 7, respectively.

FIG. 10 illustrates a one-hand-implemented change in field of view which has been created for the thermal imager by a user employing an appropriate virtual control element suitably provided on touch screen 29a. This change has, relative to what is seen in FIG. 6, for example, enlarged the field of view so that the central image of the flying helicopter is considerably smaller in FIG. 10 than in FIG. 6.

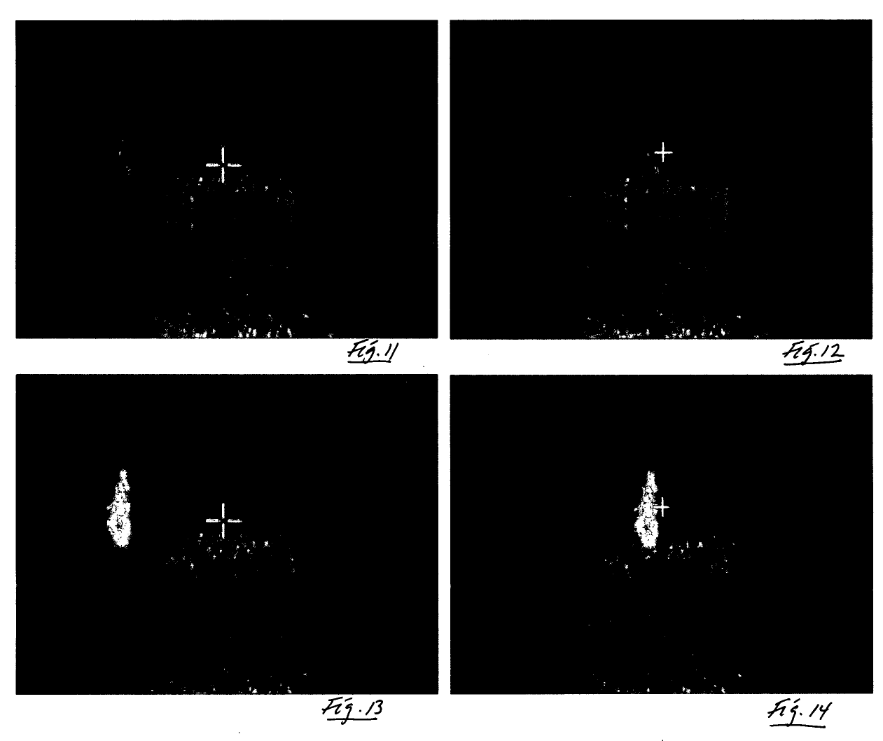

FIG. 4 illustrates another typical virtual user interface presentation of virtual controls provided on touch screen 28a under circumstances where the nighttime and thermal imagers, 14, 16, respectively, are active. FIGS. 11-14, inclusive, show such comparative imagery in the following manner. FIGS. 11 and 12 are nighttime, intensified-light, black-and-white images presented on display device 36, with the situation being such that, as between these two figures, a panning action under the control of joystick 28b has been implemented to shift the relative positions of an imaged walking person and the system's target crosshair.

FIGS. 13 and 14 show comparative thermal imagery which appears (simultaneous with related nighttime imagery appearing on the screen in device 36) on display device 34. FIG. 13 is spatially related, vis-a-vis field of view and point of view, with respect to FIG. 11. FIG. 14 bears in its relationship to FIG. 12 the same relationship which FIG. 13 bears to FIG. 11. As can be seen, the result of a panning motion is here illustrated, demonstrating how panning of housing 12 and the contained imager assembly produces common changes in imager point of view.

FIG. 5 shows yet another illustrative virtual user interface provided for control on touch screen 28a. What is specifically shown in FIG. 5 is a situation wherein, at a particular moment in time, only thermal imager 16 is active in system 10.

Thus there is proposed by the present invention a novel system and methodology which greatly simplifies, essentially to one-handed operation, user control over the entirety of the generally intricate and complex internal behavior of the imaging structure in imaging system 10. A user's visual attention, essentially, can remain devoted to imagery presented on one or both of the screens in display devices 34, 36, with only momentary orienting glances required to enable easy and convenient and accurate single-handed manipulation of various aspects of the operation of system 10, all accomplished simply by acting upon virtual control tools provided on touch screen 28a, and by manipulation of joystick 28b.

Thus, while a preferred embodiment (and certain modifications) of, and manner of practicing, the present invention have been described herein, it is appreciated that variations and modifications may be made without departing from the sprit of the invention.

1. A multi-information-character surveillance imaging system comprising
a plural-imager housing-contained assembly of surveillance imagers including (a) an optical, daytime, color video imager, (b) an optical, nighttime, light-intensified, black-and-white video imager, and (c) a thermal imager, each of said imagers being provided with computer-adjustable imager parameters control structure,
computer-controllable, motor-actuatable mounting structure operatively mounting and supporting the housing-contained imager assembly for selective and controlled surveillance tracking via generally vertical panning and generally horizontal tilting motions,
a computer, and
a user-operable controller interface operatively interposed said mounting structure, said imager parameter control structures in said imagers, and said computer, said interface including a touch-screen display device touchable by a user to effect computer-implemented imager parameter adjustments, and a joystick instrument manipulable by a user to effect computer-controlled, motor-driven surveillance tracking motions of said assembly.

2. The system of claim 1, wherein said interface is also structured, via said touch-screen display device, to enable free and variable user selection of the specific imager, or plural imagers, which are to perform imagery tracking and surveillance at any given point in time.

3. The system of claim 2 which further includes screen imagery display structure which is operatively connected effectively to at least a portion of that structure with respect to which said computer is operatively interposed, said display structure being operable to display visual, surveillance imagery information selectively drawn from any one or more of said imagers.

4. A multi-information-character, surveillance-imaging enabling method comprising
furnishing a capability for gathering plural-mode imagery employing (a) a computer-controllable, optical, daytime, color video imager, (b) a computer-controllable optical, nighttime, light-intensified, black-and-white video imager, and (c) a computer-controllable thermal imager, where computer-controllability regarding thses imagers includes the capabilities of varying the respective imagers' operating parameters, and coordinatedly, and simultaneously, panning and tilting the imagers' points of view,
operatively connecting a computer to the furnished computer-controllable imagers, and
providing a one-hand-enabling, user-operable controller interface which is operatively connected to the computer, and which includes a touch-screen display device touchable by a user to effect computer-implemented imager operating-parameter adjustments, and a joystick instrument manipulable by a user to effect computer-controlled, coordinated, simultaneous panning and tilting of the imagers' points of view.
